(19) United States
(12) Patent Application Publication
(10) Pub. No.: US 2005/0284246 A1
(43) Pub. Date: Dec. 29, 2005

(54) Gearing for a vehicle steering device with a stationary central part

(75) Inventor: Stefan Faeth, Aschaffenburg (DE)

Correspondence Address: TAROLLI, SUNDHEIM, COVELL, & TUMMINO L.L.P., 1111 LEADER BLDG., 526 SUPERIOR AVENUE, CLEVELAND, OH, 44114-1400, US

(73) Assignee: TRW Automotive Safety Systems GmbH

(21) Appl. No.: 11/152,292

(22) Filed: Jun. 15, 2005

(30) Foreign Application Priority Data
Jun. 23, 2004 (DE) 20 2004 009 837.7

(51) Int. Cl. F16H 55/18

(52) U.S. Cl. 74/409

(57) ABSTRACT

A gearing (56) for a vehicle steering device has a fixed central part. The gearing comprises a first pinion (64), an axis section (68) and a spring element (114). The first pinion (64) is coupled to the axis section (68). The first pinion (64) is formed from toothed first and second pinion parts (104, 108), which are braced against each other by means of the spring element (114). The gearing (56) is part of a steering device having a steering wheel part coupled non-rotatably to a steering column and a central part stationary with respect to a rotation of the steering wheel port.

### TECHNICAL FIELD

The invention relates to a gearing for a vehicle steering device having a stationary central part. The invention further relates to a steering device having a steering wheel part coupled non-rotatably to a steering column, a central part stationary with respect to a rotation of the steering wheel part, and a gearing.

### BACKGROUND OF THE INVENTION

Steering devices having a stationary central part basically have the advantage that operating elements arranged on the central part are always to be found at the same place irrespective of the steering wheel position. In addition, the gas bag of a gas bag module housed in a stationary central part no longer necessarily has to be constructed symmetrically to the rotation centre of the steering device. As the orientation of the gas bag, unfolding from the stationary central part, is always the same, asymmetrical gas bag shapes with better restraining characteristics can be used.

From published German patent applications DE-A-34 13 009, DE-A-34 06 327 and DE-A-35 29 832, steering wheels having a stationary central part are known. These steering wheels comprise a gearing with a pinion coupled to an axis section of the gearing. The gearing provides for an oppositely-directed transfer of the rotation of the steering wheel part, which is coupled non-rotatably to the steering column, onto the central part of the steering wheel uncoupled therefrom. Therefore, the central part effectively does not rotate with the steering wheel, but rather remains stationary. A disadvantage with such a gearing is that even with strict tolerance demands, a gearing play resulting in an undesired shaking, in particular in the case of a change of the steering wheel rotation direction, can not be ruled out.

It is an object of the invention to make possible a play-free steering in a steering device with a stationary central part in a favourably priced manner.

### BRIEF SUMMARY OF THE INVENTION

According to the invention, a gearing for a vehicle steering device having a stationary central part comprises a first pinion, an axis section and a spring element. The first pinion is coupled to the axis section. The first pinion is formed from toothed first and second pinion parts which are braced against each other by the spring elements. The bracing of the two pinion parts by means of the spring element provides in a simple manner for one of the toothed pinion parts to always be pressed against the toothed ring with which the pinion meshes. The teeth of the pinion and of the toothed ring can therefore be produced with relatively great tolerances, because the bracing of the two pinion parts with respect to each other also provides for a play-free running of the gearing with a change of the steering wheel rotation direction.

According to a preferred embodiment of the invention, the first pinion part comprises a pinion base body which is connected non-rotatably to the axis section, and the second pinion part comprises a pinion disc arranged concentrically to the pinion base body, a first end of the spring element engaging into said pinion disc.

Preferably the gearing comprises a second pinion arranged on the axis section, the second pinion having the same structure as the first pinion. Thus, a play-free oppositely-directed transfer of the rotation of the steering wheel part coupled non-rotatably to the steering column onto the central part of the steering wheel uncoupled therefrom can be ensured.

The invention also provides a steering device having a steering wheel part coupled non-rotatably to a steering column, a central part stationary with respect to a rotation of the steering wheel part, and a gearing according to the invention.

### BRIEF DESCRIPTION OF THE DRAWINGS

FIG. 1 shows a top view of a first steering device;

FIG. 2 shows a sectional view along the line A-A of FIG. 1;

FIG. 3 shows a sectional view along the line B-B of FIG. 1;

FIGS. 4a, 4b show an enlarged view of a part of a gearing in a transparent perspective and in a lateral view, respectively;

FIGS. 5a and 5b show enlarged detail views of the first steering device before and after the installation of the gas bag module; and

FIG. 6 shows a sectional view of a second steering device.

### DETAILED DESCRIPTION OF THE PREFERRED EMBODIMENTS

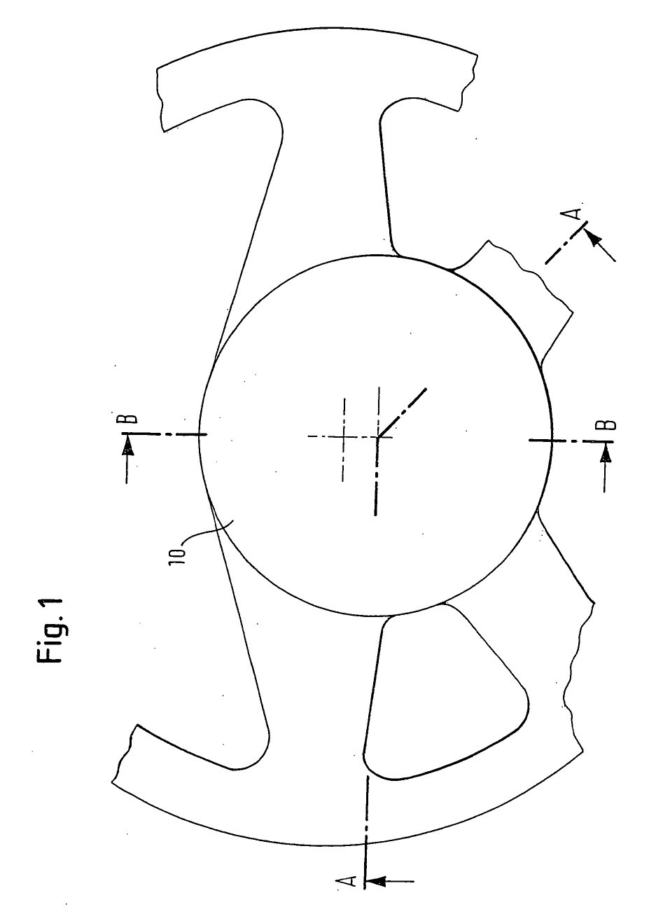

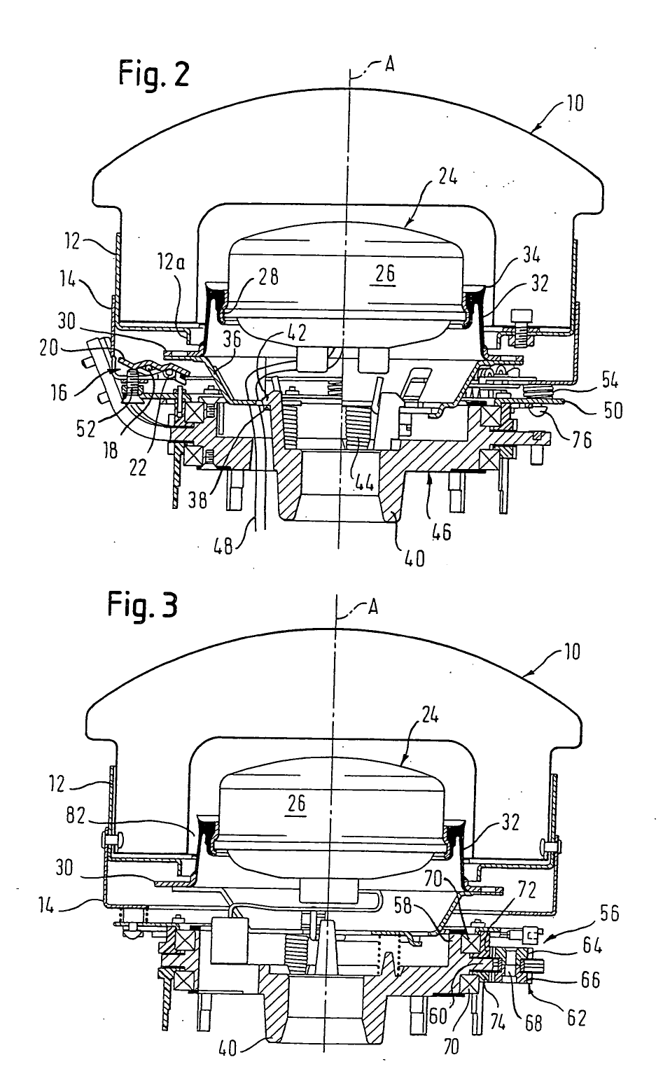

In FIGS. 1 to 3 a steering device with an installed gas bag module 10 is illustrated. The gas bag module 10 comprises an assembly with a covering and with a gas bag cage (not illustrated separately in FIGS. 2 and 3) and also a carrier plate 12 for the fastening of a gas bag (not shown) with an angled extension 12a and an outer carrier plate 14. Several locking arrangements 16 with a locking member 20 are coupled to the outer carrier plate 14. The function of the locking member 20, which is swivellable about an axis 18, will be explained later. The locking member 20 is pre-stressed by a spring 22 in an anticlockwise direction with respect to the axis 18 according to the illustration of FIG. 2.

In addition, a gas generator unit 24 is provided with a gas generator 26, a mounting plate 28 and a ring-shaped mounting flange 30 and also with an elastic mounting cylinder 32 with external extensions 34. The free edges of the elastic mounting cylinder 32 are connected on the one hand with the mounting plate 28 and on the other hand with the mounting flange 30, so that the gas generator 26 undertakes the function of a vibration amortizer. A connecting plate 36, fastened to the mounting flange 30, on the underside of which radially displaceable spring elements 38 are provided, also belongs to the gas generator unit 24.

The steering device further comprises a hub 40, connected non-rotatably to a steering column of the vehicle (not shown), with formed-on die cast hooks 42 and axially arranged springs 44 in the interior of the hub 40. A steering wheel skeleton 46 is constructed in one piece with the hub 40. A supply line 48 (only indicated diagrammatically in FIG. 2) guided into the gas generator 26, by means of which the gas generator 26 is connected with a control unit arranged outside the steering device, is guided adjacent to the hub 40 out from the steering device and to a clock spring (not shown). A plate 50, in the outer region of which pins 52 are provided, is mounted so as to be rotatable with respect to the hub 40. Springs 54 are provided between the plate 50 and the outer carrier plate 14.

The entirety of the components coupled non-rotatably to the steering column is designated hereinbelow as “the steering wheel part”.

In FIG. 3 a gearing 56 can be seen, the function of which will likewise be explained later. In a skeleton section 60, connected with the hub 40 and extending radially away from an axial section 58, a double pinion part 62 is mounted. The double pinion part 62 has two pinions 64, 66 arranged in parallel, which are connected non-rotatably with each other by an axis section 68. On the outer side of the axial skeleton section 58, two roller bearings 70 are arranged, one of which is arranged above and one below the horizontal skeleton section 60. The roller bearings 70 carry two toothings in the form of toothed rings 72, 74 running completely around the central axis A of the steering device. The toothed rings 72, 74 are in engagement with the upper pinion 64 and the lower pinion 66, respectively. The lower toothed ring 74 is mounted so as to be secure with the steering arm, whereas the upper toothed ring 72 is coupled to the gas bag module 10.

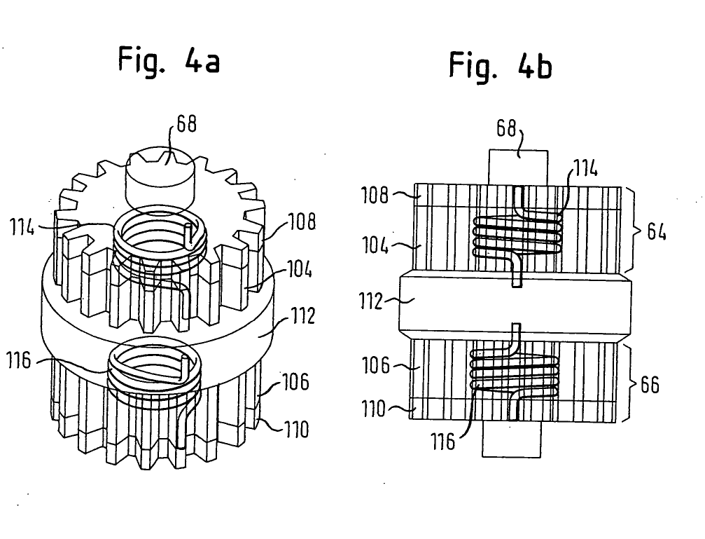

The double pinion part 62 is illustrated in detail in FIGS. 4a and 4b. The pinions 64 and 66 are both formed from a pinion base body 104, 106, respectively, and a pinion disc 108, 110, respectively, all of which are arranged concentrically on the axis section 68. Situated between the pinions 64, 66 is a central section 112 opposing the skeleton section 60. The two pinion base bodies 104, 106, the central section 112 and the axis section 68 can be constructed as separate components, as components connected securely with each other or (at least partially) in one piece. Torsion spring elements 114, 166 are embedded into the pinion base bodies 104, 106. One end of the torsion spring elements 114, 116 engages into the central section 112; the other end engages into the associated pinion disc 108, 110, respectively, so that the torsion spring elements 114, 116 brace the pinion discs 108, 110 with respect to the direction of rotation against the associated pinion base body 104, 106, respectively.

The installation of the gas bag module 10 is described below. Before installation, the gas generator unit 24 is a component of the gas bag module 10. As shown in FIG. 4a, the biased locking member 20 presses the connecting plate 36 with the mounting flange 30, fastened thereon, firmly against the extension 12a of the carrier plate 12, so that the gas generator unit 24 is held against the carrier plate 12. On insertion of the gas bag module 10 in the direction of the illustrated arrow, the gas bag module 10 is arrested in a conventional manner with the plate 50 by means of clip connections 76. During this process, the gas generator unit 24 is automatically transferred from the gas bag module 10 to the steering wheel part, as will be explained below.

On insertion, the gas bag module 10 is over-pressed against the force of the springs 54 to such an extent until through the pressure of the extension 12a onto the mounting flange 30 and the connecting plate 36, the spring elements 38 engage under the hooks 42 on the hub side. After the pressure onto the gas bag module 10 is discontinued, the springs 44 press the spring elements 38 securely against the hooks 42. At the same time, the springs 54 press the engaged gas bag module 10 upwards, so that a gap 78 occurs between the mounting flange 30 and the extension 12a. In addition, on insertion of the gas bag module 10, the locking member 20 is swivelled by the pin 52, serving as actuating member, against its biasing (anticlockwise in accordance with the illustration of FIG. 4a), so that a gap 80 also occurs between the locking member 20 and the connecting plate 36. Therefore, the gas generator unit 24 is uncoupled from the gas bag module 10 and is coupled non-rotatably to the hub 42 by means of the spring elements 38, i.e. the gas generator unit 24 is now a component of the steering wheel part. With a rotation of the steering wheel part, the supply line 48 is rotated together with the gas generator 26 and can therefore not become twisted.

So that the gas bag module 10 can remain stationary with respect to the gas generator unit 26, which is now rotatable with the steering wheel part, a gap 82 is provided between the elastic mounting cylinder 32 and the gas bag cage. The elastic mounting cylinder 32 with its external extensions 34 prevents the outflowing gases from flowing off downwards in an uncontrolled manner through this gap 82 on an activation of the gas generator 24, because the extensions 34 are pressed firmly against the gas bag cage by the outflowing gases and thus provide for a sufficient seal.

The relative movement of the steering wheel part with respect to the stationary gas bag module 10 is made possible by the gearinging unit 56. The double pinion part 62 mounted on the radial skeleton section 60 is entrained with a rotary movement of the steering wheel part. As the lower toothed ring 74 is mounted so as to be secure with the steering arm, the lower pinion 66 runs on the lower toothed ring 74. The rotation of the lower pinion 66 is transferred to the upper pinion 64, connected non-rotatably via the axial section 68. Thereby, the upper toothed ring 72, with the gas bag module lo coupled thereon, is rotated in the opposite direction to the direction of rotation of the steering wheel part, so that the gas bag module 10 effectively does not rotate with the steering wheel part, i.e. it remains stationary. The gas bag module 10 without the gas generator unit 24 therefore forms in the installed state a central part of the steering device which is stationary with respect to the steering wheel part.

The bracing of the pinion base bodies 104, 106 against the associated pinion discs 108, 110 by means of the torsion spring elements 114, 116 ensures a play-free run of the pinions 64, 66 on the toothed rings 72, 74. Due to the effect of the torsion spring elements 114, 116, always either the teeth of the pinion base bodies 104, 106 or the teeth of the pinion discs 108, 110 are pressed against the teeth of the toothed rings 72, 74. This applies in particular in the case of a change of rotation direction.

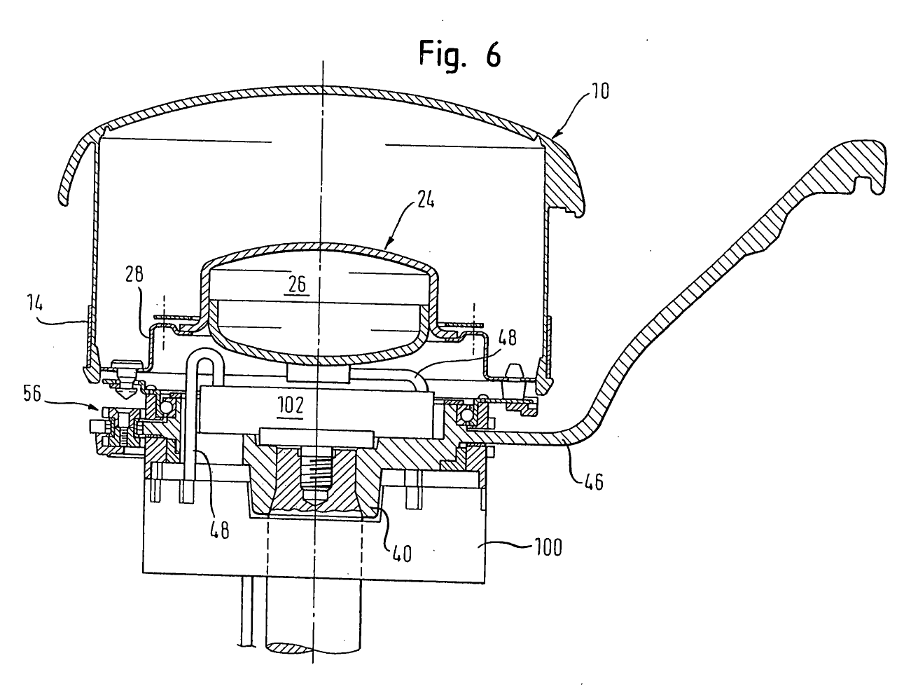

In FIG. 6 an alternative vehicle steering device according to the invention is illustrated, the same reference numbers being used as in FIGS. 1 to 3, in so far as they designate corresponding components.

The steering device corresponds largely to the steering device previously described with the difference that the gas generator unit 24 here is a fixed component of the gas bag module 10, i.e. is not passed on to the rotatable steering wheel part on installation of the gas bag module 10. Accordingly, with a rotation of the steering wheel part, the gas generator 26 does not rotate therewith. The problem of the wiring of the gas generator 26 is solved here by an auxiliary clock spring 100, which is provided in addition to a main clock spring 102.

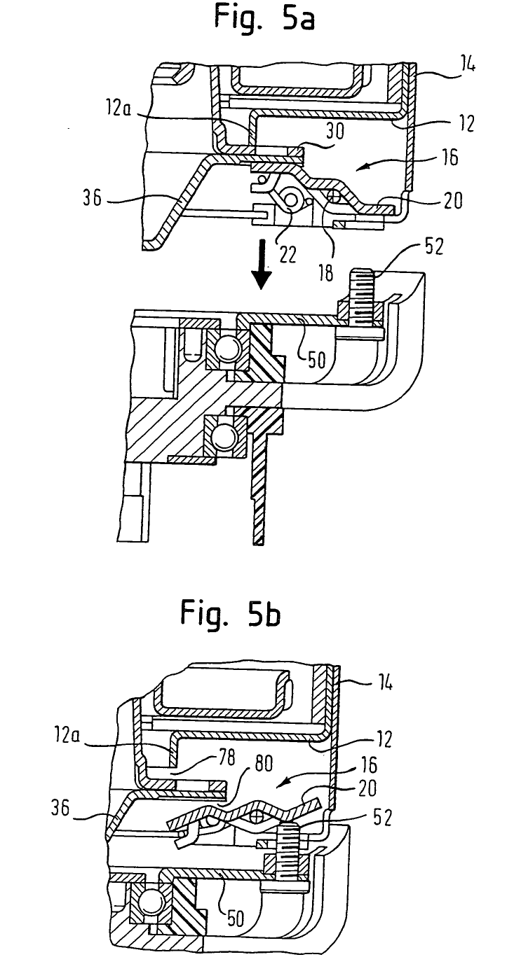

The principle of the wiring of components, which are arranged on a conventional steering wheel without a stationary central part, by means of a clock spring, is sufficiently known and is therefore not explained in further detail here. As in the steering device illustrated in FIG. 5 the gas generator unit 24, however, belongs to the stationary central part of the steering wheel, such a wiring with only one clock spring is not expedient here.

The supply line 48 for the gas generator 26 is therefore guided from the main clock spring 102 arranged in a non-rotatable (stationary) section of the steering device, into the auxiliary wound spring 100 arranged in the rotatable steering wheel part, and from there into the gas generator 26. Of course, further supply lines for other steering wheel functional units, such as for instance a horn or multi-functional switch, can be laid in the same manner.

1. A gearing for a vehicle steering device having a stationary central part, said gearing comprising a first pinion, an axis section and a spring element, said first pinion being coupled to said axis section, said first pinion being formed from toothed first and second pinion parts which are braced against each other by said spring element.

2. The gearing according to claim 1, wherein said first pinion part comprises a pinion base body which is connected non-rotatably to said axis section.

3. The gearing according to claim 2, wherein said second pinion part comprises a pinion disc arranged concentrically to said pinion base body, a first end of said spring element engaging into said pinion disc.

4. The gearing according to claim 1, wherein a second end of said spring element engages into a member of said gearing which is non-rotatably connected to said axis section.

5. The gearing according to claim 1, wherein on said axis section a second pinion is arranged, which has the same structure as said first pinion.

6. The gearing according to claim 5, wherein between said first and second pinions a central section is provided, into which said second ends of said spring elements engage.

7. The gearing according to claim 6, wherein at least said pinion base bodies and said central section are constructed in one piece.

8. The gearing according to claim 7, wherein said pinion base bodies, said central section and said axis section are constructed in one piece with each other.

9. A steering device having a steering wheel part coupled non-rotatably to a steering column, a central part stationary with respect to a rotation of said steering wheel part, and a gearing, said gearing comprising a first pinion, an axis section and a spring element, said first pinion coupled to said axis section, said first pinion being formed from toothed first and second pinion parts, which are braced against each other by said spring element.

10. The steering device according to claim 9, wherein said gearing is mounted on said steering wheel part which is coupled non-rotatably to said steering column.

11. The steering device according to claim 10, wherein on said axis section a second pinion is arranged, which has the same structure as said first pinion, said first and second pinions meshing with toothed first and second rings, respectively, said first toothed ring being mounted onto said stationary central part and said second toothed ring being mounted so as to be fixed to the vehicle.
